(19) United States
(12) Patent Application Publication
(10) Pub. No.: US 2015/0104650 A1
(43) Pub. Date: Apr. 16, 2015

(54) ADHESIVE COMPOSITION FOR POLARIZING PLATE, POLARIZING PLATE INCLUDING THE SAME, AND DISPLAY APPARATUS INCLUDING THE SAME

(71) Applicant: SAMSUNG SDI CO., LTD., Gyeongsangbuk-do (KR)

(72) Inventors: Mi Yeon Yu, Uiwang-si (KR); Do Heon Lee, Uiwang-si (KR); Tae Hyun Lee, Uiwang-si (KR); In Cheon Han, Uiwang-si (KR)

(21) Appl. No.: 14/470,787

(22) Filed: Aug. 27, 2014

(30) Foreign Application Priority Data
Oct. 11, 2013 (KR) 10-2013-0121541

(51) Int. Cl. C09J 163/00; G02B 5/30; G02B 1/10

(52) U.S. Cl. CPC C09J 163/00; G02B 1/105; G02B 5/30
USPC 428/414; 522/25; 252/183.11

(57) ABSTRACT

An adhesive composition for polarizing plates includes: (A) a non-(meth)acrylate type epoxy compound; (B) a non-epoxy type (meth)acrylate compound; and (C) a (meth)acrylate group-containing epoxy compound. A polarizing plate includes an adhesive layer formed from the adhesive composition on a polarizer, and a protective film on the adhesive layer. A display apparatus includes the polarizing plate.

### CROSS-REFERENCE TO RELATED APPLICATION

This application claims priority to and the benefit of Korean Patent Application No. 10-2013-0121541, filed on Oct. 11, 2013 in the Korean Intellectual Property Office, the entire content of which is incorporated herein by reference.

### BACKGROUND

1. Technical Field

The present invention relates to an adhesive composition for a polarizing plate, a polarizing plate including the same, and a display apparatus including the same.

2. Description of the Related Art

An adhesive composition for a polarizing plate is used to bond a protective film to one or both surfaces of a polarizer including a PVA film. As the adhesive for polarizing plates, a hydrophilic and water-soluble water-based PVA adhesive is widely used. However, in a polarizing plate prepared using a water-based adhesive, the dimensions of the polarizing plate change due to heat from the backlight unit, and distortion due to such dimensional change is localized in a portion of the screen. As a result, when black color is displayed on the overall screen, significant light leakage can occur (e.g., a rainbow stain may appear, which indicates a partial light leak). Thus, use of a cationic polymerizable UV curable adhesive has been proposed in place of a water-based adhesive.

However, cationic polymerizable UV curable adhesives suffer from dark reactions (post-polymerization) after UV irradiation when the cured product is wound into a roll during storage. In addition, cationic polymerizable UV curable adhesives are easily affected by humidity upon curing and are likely to suffer deviations of the curing state. Thus, to realize a uniform curing state, strict controls must be placed on environmental humidity and the moisture content of the PVA polarizer. In recent years, polarizing plates have been used in severe environments, giving rise to an increased demand for polarizing plates exhibiting reliable moisture resistance and durability under severe moisture environments, such as high humidity environments, water immersion environments and the like.

### SUMMARY

In accordance with an aspect of the present invention, an adhesive composition for polarizing plates may include: (A) a non-(meth)acrylate type epoxy compound; (B) a non-epoxy type (meth)acrylate compound; and (C) a (meth)acrylate group-containing epoxy compound.

In accordance with another aspect of the present invention, a polarizing plate may include: a polarizer; and a protective film on one or both surfaces of the polarizer via an adhesive layer. The adhesive layer may be formed of the above-described adhesive composition for polarizing plates.

In accordance with a further aspect of the present invention, a display apparatus may include the polarizing plate.

### BRIEF DESCRIPTION OF THE DRAWINGS

FIG. 1 is a schematic cross-sectional view of a polarizing plate according to one embodiment of the present invention.

FIG. 2 is a schematic cross-sectional view of a display apparatus according to one embodiment of the present invention.

### DETAILED DESCRIPTION

Embodiments of the present invention are described with reference to the accompanying drawings. It should be understood that the present invention may be embodied in different ways and is not limited to the following embodiments. In the drawings, portions not relevant to the description are omitted for clarity. Like components are denoted by like reference numerals throughout the specification and drawings. As used herein, terms such as “upper” and “lower” are defined with reference to the accompanying drawings. Thus, it will be understood that the term “upper” (e.g., “upper side”) can be used interchangeably with the term “lower side” (e.g., “lower side”). As used herein, the term “(meth)acrylate” may refer to acrylates and/or methacrylates, and the term “compound” may include monomers, oligomers, resins, and the like.

According to embodiments of the invention, an adhesive composition for polarizing plates is useful to bond a protective film, such as triacetyl cellulose (TAC), polyethylene terephthalate (PET), polycarbonates (PC), cyclic olefin polymers (COPs), acrylic films, and the like, to one or both surfaces of a polarizer. The adhesive composition may be a photocurable composition.

According to one embodiment of the invention, the adhesive composition for polarizing plates may include: (A) a non-(meth)acrylate type epoxy compound; (B) a non-epoxy type (meth)acrylate compound; and (C) a (meth)acrylate group-containing epoxy compound.

### (A) Non-(meth)acrylate Type Epoxy Compound

The non-(meth)acrylate type epoxy compound can improve interfacial adhesion between the polarizer and the protective film, and provide good reliability to the adhesive layer due to the structural strength of the epoxy group. In addition, the non-(meth)acrylate type epoxy compound enables the physical twist of molecular chains between the non-(meth)acrylate type epoxy compound and the cured product of a (meth)acrylate compound (described below). Additionally, the non-(meth)acrylate type epoxy compound can provide cohesion to the adhesive layer by chain transfer bonding to a hydrophilic group of the (meth)acrylate compound.

In addition, the non-(meth)acrylate type epoxy compound can support the structure of the adhesive layer and impart durability to the adhesive layer due to its high glass transition temperature (Tg). Additionally, the non-(meth)acrylate type epoxy compound can improve interfacial adhesion to the polarizer and the protective film due to chemical bonding to the polarizer and the protective film and good wettability caused by a hydroxyl group generated upon curing. In one embodiment, the non-(meth)acrylate type epoxy compound has a glass transition temperature (Tg) of about 50° C. to about 250° C., for example, about 100° C. to about 200° C. Within either of these ranges, the adhesive composition can exhibit improved durability and improved interfacial adhesion to the polarizer and the protective film.

The non-(meth)acrylate type epoxy compound is a non-(meth)acrylate compound that is free of a (meth)acrylate group, and is an epoxy cationic compound that may contain at least one epoxy group and is polymerizable by a cation generated from a photocationic polymerization initiator. In some embodiments, the non-(meth)acrylate type epoxy compound may include at least one alicyclic, aromatic, aliphatic, and/or hydrogenated epoxy compound.

The alicyclic epoxy compound may be a compound in which an alicyclic group has at least one epoxy group, and may include, for example, an alicyclic diepoxy carboxylate. In some embodiments, the alicyclic epoxy compound may include 3,4-epoxycyclohexylmethyl-3′,4′-epoxycyclohexanecarboxylate, 2-(3,4-epoxycyclohexyl-5,5-spiro-3,4-epoxy)cyclohexane-meta-dioxane, bis(3,4-epoxycyclohexylmethyl)adipate, bis(3,4-epoxy-6-methylcyclohexyl)adipate, 3,4-epoxy-6-methylcyclohexyl-3′,4′-epoxy-6′-methylcyclohexanecarboxylate, ε-caprolactone-modified 3,4-epoxycyclohexylmethyl-3′,4′-epoxycyclohexanecarboxylate, trimethylcaprolactone-modified 3,4-epoxycyclohexylmethyl-3′,4′-epoxycyclohexanecarboxylate, β-methyl-δ-valerolactone-modified 3,4-epoxycyclohexylmethyl-3′4,′-epoxycyclohexanecarboxylate, methylenebis(3,4-epoxycyclohexane), di(3,4-epoxycyclohexylmethyl)ether of ethylene glycol, ethylenebis(3,4-epoxycyclohexanecarboxylate), dioctyl epoxycyclohexahydrophthalate, di-2-ethylhexyl epoxycyclohexahydrophthalate, or the like.

The aromatic epoxy compound may include at least one epoxy group-containing bisphenol A, bisphenol F, phenol novolac, cresol novolac, bisphenol A-novolac, dichloropentadiene novolac, glycidyl ether of triphenylmethane, triglycidyl p-aminophenol, tetraglycidyl methylene dianiline, or the like.

The aliphatic epoxy compound may be an at least one epoxy group-containing aliphatic compound, and may include, for example, 1,4-butanediol diglycidyl ether, 1,6-hexanediol diglycidyl ether, neopentyl glycol diglycidyl ether, trimethylolpropane triglycidyl ether, polyethylene glycol diglycidyl ether, glycerin triglycidyl ether, a polypropylene glycol diglycidyl ether; a polyglycidyl ether of a polyether polyol obtained by adding at least one alkylene oxide to an aliphatic polyhydric alcohol, such as ethylene glycol, propylene glycol, glycerin, or the like; a diglycidyl ester of an aliphatic long-chain dibasic acid; a monoglycidyl ether of an aliphatic higher alcohol; a glycidyl ether of a higher fatty acid; epoxidized soybean oil; butyl epoxystearate; octyl epoxystearate; epoxidized linseed oil; epoxidized polybutadiene, or the like.

The hydrogenated epoxy compound may be a resin obtained by the selective hydrogenation of an aromatic epoxy resin in the presence of a catalyst under pressure. Nonlimiting examples of the aromatic epoxy resin may include: bisphenol type epoxy resins such as diglycidyl ethers of bisphenol A, diglycidyl ethers of bisphenol F, diglycidyl ethers of bisphenol S, and the like; novolac type epoxy resins, such as phenol novolac epoxy resins, cresol novolac epoxy resins, and hydroxybenzaldehyde phenol novolac epoxy resins; polyfunctional epoxy resins, such as glycidyl ethers of tetrahydroxyphenylmethane, glycidyl ethers of tetrahydroxybenzophenone, epoxidized polyvinyl phenol, and the like. Although the hydrogenated epoxy resin may be obtained by adding hydrogen to a mother nucleus of the aromatic epoxy resin, the hydrogenated epoxy compound may be a hydrogenated glycidyl ether of bisphenol A (as an example of an aromatic epoxy resin).

The non-(meth)acrylate type epoxy compound may be present in an amount of about 40% by weight (wt %) to about 90 wt %, for example about 40 wt % to about 60 wt %, or about 40 wt % to about 50 wt %, based on the total weight of (A)+(B)+(C) (i.e., (A) a non-(meth)acrylate type epoxy compound; (B) a non-epoxy type (meth)acrylate compound; and (C) a (meth)acrylate group-containing epoxy compound). Within any of these ranges, the adhesive composition can exhibit good adhesion to the polarizer and the protective film, and prevent (or reduce) deteriorations in wettability to the polarizer due to excessive increases in viscosity. In addition, breakage of the adhesive layer due to excessive increases in storage modulus can be prevented (or the risk of breakage can be reduced), and the adhesive layer can exhibit good crack resistance and cuttability.

The non-(meth)acrylate type epoxy compound may be present in an amount of about 40wt % to about 90 wt %, for example about 40 wt % to about 60 wt %, or about 40 wt % to about 50 wt %, based on the total solids content of the adhesive composition. Within any of these ranges, the adhesive composition can exhibit good adhesion to the polarizer and the protective film, and prevent (or reduce) deteriorations in wettability to a substrate due to increases in viscosity. In addition, breakage of the adhesive layer due to excessive increases in storage modulus can be prevented (or the risk of breakage can be reduced), and the adhesive layer can exhibit good crack resistance and cuttability.

(B) Non-Epoxy Type (meth)acrylate Compound

The non-epoxy type (meth)acrylate compound exhibits high reactivity without inhibiting the reaction due to moisture in the polarizer, and can improve interfacial adhesion to the polarizer and the protective film by chain transfer bonding to a hydrophilic group of the epoxy compound activated during curing.

The non-epoxy type (meth)acrylate compound may be a polymerizable (meth)acrylate compound which can be polymerized by a radical using a photosensitizer as an initiator, and may be a non-epoxy type compound free of an epoxy group.

The non-epoxy type (meth)acrylate compound contains at least one hydrophilic group and allows chain transfer bonding to the cured product of the epoxy compound, thereby improving cohesion of the adhesive layer. The hydrophilic group may be a hydroxyl group or a carboxylic acid group. In some embodiments, the hydrophilic group is a hydroxyl group. In one embodiment, the non-epoxy type (meth)acrylate compound may include a hydrophilic group-containing (meth)acrylate compound, for example, at least one of a hydrophilic group-containing C₁ to C₂₀ alkyl(meth)acrylate, a hydrophilic group-containing C₃ to C₂₀ alicyclic(meth)acrylate, and/or a hydrophilic group-containing C₆ to C₂₀ aromatic(meth)acrylate.

For example, the hydrophilic group-containing (meth)acrylate compound may include at least one of 2-hydroxyethyl(meth)acrylate, 4-hydroxybutyl(meth)acrylate, 2-hydroxypropyl(meth)acrylate, 2-hydroxybutyl(meth)acrylate, 6-hydroxyhexyl(meth)acrylate, 1,4-cyclohexanedimethanol mono(meth)acrylate, 1-chloro-2-hydroxypropyl(meth)acrylate, diethylene glycol mono(meth)acrylate, 1,6-hexanediol mono(meth)acrylate, 2-hydroxy-3-phenoxypropyl(meth)acrylate, 2-hydroxy-3-phenoxybutyl(meth)acrylate, and/or 4-hydroxycyclohexyl(meth)acrylate but the hydrophilic group-containing (meth)acrylate compound is not limited thereto.

The hydrophilic group-containing (meth)acrylate compound may be present in the non-epoxy type (meth)acrylate compound in an amount of about 50 wt % to about 100 wt %, for example, about 65 wt % to about 100 wt %. Within any of these ranges, the adhesive composition can exhibit improved durability and improved interfacial adhesion to the polarizer and the protective film.

The hydrophilic group-containing (meth)acrylate compound may be present in the adhesive composition in an amount of about 30 wt % to about 50 wt % based on the total weight of (A)+(B)+(C) (i.e., (A) a non-(meth)acrylate type epoxy compound; (B) a non-epoxy type (meth)acrylate compound; and (C) a (meth)acrylate group-containing epoxy compound). Within this range, the adhesive composition can exhibit improved durability and improved interfacial adhesion to the polarizer and the protective film.

The non-epoxy type (meth)acrylate compound may further include a hydrophilic group-free (meth)acrylate compound, and thus can improve adhesion to the hydrophobic protective film or polarizer and further improve adhesion and water resistance of the adhesive layer under high humidity conditions. The hydrophilic group-free (meth)acrylate compound may be an aromatic group-containing (meth)acrylate compound, and may include, for example, at least one aromatic group. For example, the hydrophilic group-free (meth)acrylate compound may include a phenoxy group-containing C₁ to C₅ alkyl(meth)acrylate or a phenoxy group- and hydroxyl group-containing C₁ to C₅ alkyl(meth)acrylate. The hydrophilic group-free (meth)acrylate compound can allow the adhesive composition to exhibit improved durability and interfacial adhesion to the polarizer and the protective film.

The aromatic group-containing (meth)acrylate compound may be optionally present in the non-epoxy type (meth)acrylate compound in an amount of about 0 wt % to about 50 wt %, for example, about 0 wt % to about 35 wt %, or about 0.001 wt % to about 35 wt %. Within any of these ranges, the adhesive composition can exhibit improved durability and improved interfacial adhesion to the polarizer and the protective film.

The aromatic group-containing (meth)acrylate compound may be optionally present in the adhesive composition in an amount of about 0 wt % to about 20 wt %, for example, about 0 wt % to about 15 wt %, or about 0.1 wt % to about 15 wt %. Within any of these ranges, the adhesive layer can exhibit improved durability and improved interfacial adhesion to the polarizer and the protective film.

In one embodiment, the non-epoxy type (meth)acrylate compound may include the hydrophilic group-containing (meth)acrylate compound alone. In another embodiment, the non-epoxy type (meth)acrylate compound may include a mixture of the (B1) hydrophilic group-containing (meth)acrylate compound and the (B2) aromatic group-containing (meth)acrylate compound, and a weight ratio of B1 to B2 (B1:B2) of the mixture may be about 1:0.5 to about 1:2, for example about 1:0.5 to about 1:1. Within either of these ranges, the adhesive layer can exhibit improved durability and improved interfacial adhesion to the polarizer and the protective film.

The non-epoxy type (meth)acrylate compound may be present in the adhesive composition in an amount of about 9 wt % to about 50 wt %, for example, about 39 wt % to about 50 wt %, for example, about 40 wt % to about 50 wt % based on a total weight of (A)+(B)+(C) (i.e., (A) a non-(meth)acrylate type epoxy compound; (B) a non-epoxy type (meth)acrylate compound; and (C) a (meth)acrylate group-containing epoxy compound). Within any of these ranges, the adhesive composition can prevent (or reduce) deteriorations in adhesion due to deteriorations in cohesion, and can prevent (or reduce) deteriorations in reliability by preventing (or reducing) loss of tack, which can occur upon deteriorations in interfacial adhesion and storage modulus. Additionally, the adhesive composition can exhibit good water resistance by preventing decolorization of the polarizer upon dipping in hot water.

The non-epoxy type (meth)acrylate compound may be present in the adhesive composition in an amount of about 9 wt % to about 50 wt %, for example, about 40 wt % to about 50 wt %, based on the total solids content of the adhesive composition. Within any of these ranges, the adhesive composition can prevent (or reduce) deteriorations in adhesion due to deteriorations in cohesion, and can prevent (or reduce) deteriorations in reliability by preventing (or reducing) loss of tack, which can occur upon deteriorations in interfacial adhesion and storage modulus. Additionally, the adhesive composition can exhibit good water resistance by preventing decolorization of the polarizer upon dipping in hot water.

The epoxy compound (A) may be present in the adhesive composition in an amount of about 40 wt % to about 99.9 wt % based on the total weight of (A)+(B), and the (meth)acrylate type compound (B) may be present in the adhesive composition an amount of about 0.1 wt % to about 60 wt % based on the total weight of (A)+(B). Within these ranges, the adhesive composition can exhibit satisfactory adhesion to the polarizer and the protective film, and have good reliability. In some embodiments, the (A) epoxy compound may be present in the adhesive composition in an amount of about 50 wt % to about 60 wt % based on the total weight of (A)+(B), and the (B) (meth)acrylate compound may be present in the adhesive composition in an amount of about 40 wt % to about 50 wt % based on the total weight of (A)+(B).

### (C) (Meth)acrylate Group-Containing Epoxy Compound

The adhesive composition including the (A) non-(meth)acrylate type epoxy compound and the (B) non-epoxy type (meth)acrylate compound can exhibit good cohesion by enabling the physical twist of molecular chains between respective cured products of the epoxy compound and the (meth)acrylate compound, and by enabling the chemical bonding caused by chain transfer bonding of hydroxyl groups included in the epoxy compound and the (meth)acrylate compound, thereby maintaining adhesion under general humidity conditions (at 60° C. and 90% RH). However, the above adhesive composition may suffer deteriorations in adhesion under severe humidity conditions (for example, waterlogging or high humidity), which may lead to separation of the protective film from the polarizer.

Since the (meth)acrylate group-containing epoxy compound has a weaker cured structure than the epoxy compound and can improve the degree of curing of the cured product of the (meth)acrylate compound (having a lower glass transition temperature than that of the epoxy compound), the (meth)acrylate group-containing epoxy compound can improve adhesion of the adhesive layer and durability of the polarizing plate even under severe moisture permeable conditions (such as high humidity, waterlogging and the like), thereby preventing separation of the protective film from the polarizer even under severe humidity conditions. In addition, since the (meth)acrylate group-containing epoxy compound improves the cross-linking density of the adhesive layer due to polyfunctional properties caused by the epoxy group and the (meth)acrylate group, the (meth)acrylate group-containing epoxy compound can improve cohesion of the adhesive layer and thus improve reliability of the polarizing plate. The (meth)acrylate group of the (meth)acrylate group-containing epoxy compound may be cured by a photosensitizer.

The (meth)acrylate group-containing epoxy compound includes both an epoxy group and a (meth)acrylate group. For example, the epoxy group may be an aromatic, alicyclic, aliphatic or hydrogenated epoxy group, for example an aromatic epoxy group containing a bisphenol group, such as bisphenol A, bisphenol F, bisphenol S or the like, a naphthalene group, or a biphenyl group. The (meth)acrylate group may be a monofunctional or polyfunctional (meth)acrylate group, for example a polyfunctional (meth)acrylate group. When the (meth)acrylate group is a polyfunctional (meth)acrylate group, deteriorations in water resistance and adhesion of the adhesive layer upon dipping in hot water can be reduced.

In some embodiments, the (meth)acrylate group-containing epoxy compound may include bisphenol A epoxy (meth)acrylate, bisphenol A epoxy di(meth)acrylate, bisphenol F epoxy (meth)acrylate, bisphenol F epoxy di(meth)acrylate, or the like. For example, a bisphenol A epoxy (meth)acrylate or a bisphenol A epoxy di(meth)acrylate can further improve the water resistance of the polarizing plate.

The (meth)acrylate group-containing epoxy compound may have a weight average molecular weight of about 500 g/mol to about 1000 g/mol. Within this range, the adhesive composition can exhibit improved durability.

The (meth)acrylate group-containing epoxy compound may contain a hydroxyl group, thereby improving adhesion of the adhesive composition.

The (meth)acrylate group-containing epoxy compound may be present in the adhesive composition in an amount of about 1 wt % to about 19 wt %, for example, about 1 wt % to about 15 wt %, for example, about 1 wt % to about 10 wt %, for example, about 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, or 19 wt % based on the total weight of (A)+(B)+(C) (i.e., (A) a non-(meth)acrylate type epoxy compound; (B) a non-epoxy type (meth)acrylate compound; and (C) a (meth)acrylate group-containing epoxy compound). Within any of these ranges, the adhesive composition can exhibit improved adhesion at high humidity and can prevent (or reduce) deteriorations in interfacial adhesion between the polarizer and the protective film.

The (meth)acrylate group-containing epoxy compound may be present in the adhesive composition in an amount of about 0.5 wt % to about 19 wt %, for example about 0.5 wt % to about 10 wt %, for example, about 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12.5 wt %, 13 wt %, 13.5 wt %, 14 wt %, 14.5 wt %, 15 wt %, 15.5 wt %, 16 wt %, 16.5 wt %, 17 wt %, 17.5 wt %, 18 wt %, 18.5 wt %, or 19 wt %. Within any of these ranges, the adhesive composition can exhibit improved adhesion at high humidity, and can prevent (or reduce) deteriorations in interfacial adhesion to the polarizer and the protective film.

The non-epoxy type (meth)acrylate compound and the (meth)acrylate group-containing epoxy compound may be present in the adhesive composition in a total amount of about 60 wt % or less, for example, about 5 wt % to about 50 wt %, for example, about 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, or 50 wt %. Within any of these ranges, the adhesive composition can prevent (or reduce) deteriorations in adhesion due to deteriorations in cohesion of the cured product, prevent (or reduce) deteriorations in interfacial adhesion, and prevent (or reduce) deteriorations in water resistance (that is, decolorization of the polarizing plate due to deteriorations in storage modulus upon dipping in hot water).

The adhesive composition may further include at least one of (D) a photosensitizer and/or (E) a photocationic polymerization initiator.

### (D) Photosensitizer

The photosensitizer generates a small number of radicals to catalyze the curing reaction. According to one embodiment, since the adhesive composition for polarizing plates includes both the epoxy compound (A) and the (meth)acrylate compound (B), the adhesive composition has a hybrid cured structure. The photosensitizer allows curing of the (meth)acrylate compound and serves to catalyze the initiation reaction of the photocationic polymerization initiator, which cures the (meth)acrylate compound, thereby improving reactivity of the photocationic polymerization initiator.

The photosensitizer may include phosphorus, triazine, acetophenone, benzophenone, thioxanthone, benzoin, oxime photosensitizers, or a mixture thereof. In one embodiment, the photosensitizer may include a thioxanthone photosensitizer.

The photosensitizer may be present in an amount of about 0.1 parts by weight to about 10 parts by weight, for example about 0.5 parts by weight to about 6.0 parts by weight based on 100 parts by weight of (A)+(B)+(C) (i.e., (A) a non-(meth)acrylate type epoxy compound; (B) a non-epoxy type (meth)acrylate compound; and (C) a (meth)acrylate group-containing epoxy compound). Within any of these ranges, the (meth)acrylate compound can be sufficiently cured under light intensive process conditions, and reactivity of the photocationic polymerization initiator can be improved.

### (E) Photocationic Polymerization Initiator

The photocationic polymerization initiator may include any suitable photocationic polymerization initiator which can initiate a photocuring reaction.

The photocationic polymerization initiator may include an onium ion as a cation, and a corresponding anion to prepare an onium salt. Nonlimiting examples of the onium ion may include: diaryliodonium such as diphenyliodonium, 4-methoxydiphenyliodonium, bis(4-methylphenyl)iodonium, bis(4-tert-butylphenyl)iodonium, bis(dodecylphenyl)iodonium, and the like; triarylsulfonium such as triphenylsulfonium, diphenyl-4-thiophenoxyphenylsulfonium, and the like; bis[4-(diphenylsulfonio)-phenyl]sulfide; bis[4-(di(4-(2-hydroxyethyl)phenyl)sulfonio)-phenyl]sulfide; 5-2,4-(cyclopentadienyl)[1,2,3,4,5,6-η]-(methylethyl)-benzene]-iron (1+), and the like. Nonlimiting examples of the anion may include tetrafluoroborate (BF₄⁻), hexafluorophosphate (PF₆⁻), hexafluoroantimonate (SbF₆⁻), hexafluoroarsenate (AsF₆⁻), hexachloroantimonate (SbCl₆⁻), and the like.

The photocationic polymerization initiator may be present in the adhesive composition in an amount of about 0.1 parts by weight to about 10 parts by weight, for example about 0.1 parts by weight to about 6 parts by weight based on 100 parts by weight of (A)+(B)+(C) (i.e., (A) a non-(meth)acrylate type epoxy compound; (B) a non-epoxy type (meth)acrylate compound; and (C) a (meth)acrylate group-containing epoxy compound). Within either of these ranges, the epoxy compound can be sufficiently polymerized, and residual initiator can be prevented or reduced.

In some embodiments, the adhesive composition may include about 40 wt % to about 90 wt % of the (A) non-(meth)acrylate type epoxy compound, about 9 wt % to about 50 wt % of the (B) non-epoxy type (meth)acrylate compound, about 0.5 wt % to about 19 wt % of the (C) (meth)acrylate group-containing epoxy compound, about 0.01 wt % to about 3 wt % of the (D) photosensitizer, and about 0.01 wt % to about 5 wt % of the (E) photocationic polymerization initiator, based on the total solids content of the adhesive composition. Within these ranges, the polarizing plate can exhibit good water resistance, adhesion and reliability in severe moisture permeable environments.

The adhesive composition for polarizing plates may be prepared by mixing the (A) non-(meth)acrylate type epoxy compound, the (B) non-epoxy type (meth)acrylate compound, the (C) (meth)acrylate group-containing epoxy compound, the (D) photosensitizer, and the (E) photocationic polymerization initiator.

The adhesive composition for polarizing plates may further include additives, such as antioxidants, UV absorbers, ionic conductive agents, conductivity imparting agents such as conductive metal oxide particles and the like, light diffusivity imparting agents, viscosity modifiers, and the like, so long as the additives do not interfere with the effects of embodiments of the present invention.

The adhesive composition for polarizing plates may be prepared by mixing the aforementioned components, and may have a viscosity at 25° C. of less than about 150 cPs. Within this range, the adhesive composition can exhibit good coatability. In some embodiments, the adhesive composition has a viscosity of about 1 cPs to about 135 cPs, or about 40 cPs to about 135 cPs, or about 40 cPs to about 100 cPs.

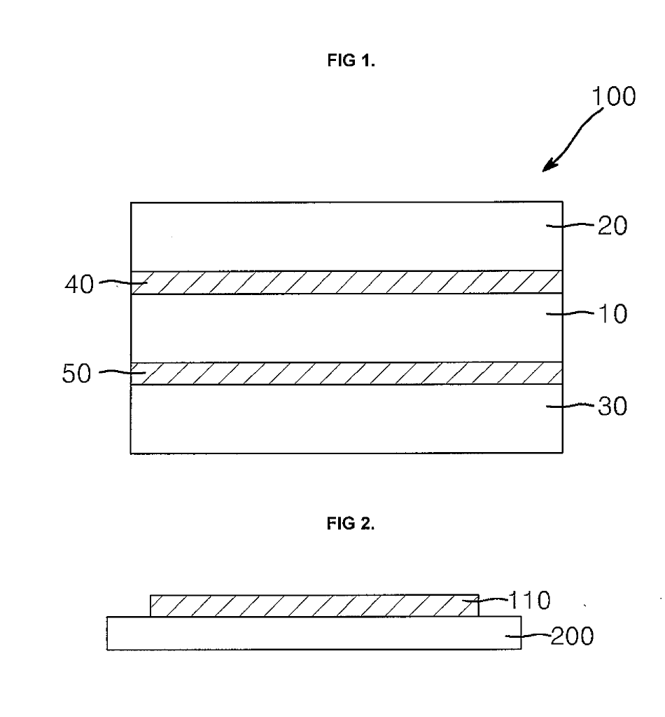

In accordance with another aspect of the present invention, a polarizing plate may include an adhesive layer formed of the adhesive composition for polarizing plates according to embodiments of the present invention. Hereinafter, a polarizing plate according to one embodiment of the invention will be described with reference to FIG. 1. FIG. 1 is a schematic cross-sectional view of a polarizing plate according to one embodiment of the invention.

Referring to FIG. 1, a polarizing plate 100 may include: a polarizer 10; a first protective film 20 on a first surface (e.g., an upper surface) of the polarizer 10; a second protective film 30 on a second surface (e.g., a lower surface) of the polarizer 10; a first adhesive layer 40 between the polarizer 10 and the first protective film 20; and a second adhesive layer 50 between the polarizer 10 and the second protective film 30. At least one of the first and second adhesive layers 40, 50 may be formed of the adhesive composition for polarizing plates according to an embodiment of the present invention. As a result, the polarizing plate can exhibit water resistance and reliability in severe moisture permeable environments, such as high humidity environments, waterlogging environments and the like, and can exhibit high cohesion, durability, cross-linking density, high adhesion, and high reliability.

The polarizer may be prepared from a film formed of a polyvinyl alcohol resin. The polyvinyl alcohol resin may include saponified products of polyvinyl alcohol, polyvinyl formal, polyvinyl acetal, ethylene vinyl acetate copolymer, or the like. The film formed of a polyvinyl alcohol resin may have a degree of saponification of about 99 mol % or greater, for example about 99 mol % to about 99.5 mol %, and a degree of polymerization of about 2,000 or greater, for example about 2,000 to about 2,500. The polarizer or the film formed of a polyvinyl alcohol resin may have a thickness of about 10 μm to about 200 μm. Within this range, the polarizer can be applied to a polarizing plate for an optical display apparatus. The polarizer can be prepared by dyeing the film formed of a polyvinyl alcohol resin with iodine, followed by stretching. The film may be stretched at a stretching ratio of about 2.0 to about 6.0. After stretching, the film may be subjected to color compensation by dipping the film in a boric acid solution and in an aqueous solution of potassium iodide.

The protective film may be any transparent film suitable for polarizing plates, without limitation. For example, the protective film may be a film formed of at least one of celluloses (including triacetyl cellulose (TAC) and the like), polyesters (including polyethylene terephthalate (PET) and the like), cyclic olefin polymers (COPS), acrylics, polycarbonates (PC), polyacrylates, polyethersulfones, polysulfones, polyamides, polyimides, polyolefins, polyarylates, polyvinyl alcohols, polyvinyl chlorides, and/or polyvinylidene chloride resins. The protective film may have a thickness of about 25 μm to about 500 μm. Within this range, the protective film can be applied to a polarizing plate when stacked on a polarizing device. In some embodiments, the protective film has a thickness of about 25 μm to about 100 μm.

The protective film may be subjected to surface treatment, for example, corona pre-treatment at about 250 mJ/cm² or greater before coating the adhesive composition or before preparation of the polarizing plate.

The adhesive layer may have a thickness of about 1 μm to about 10 μm. Within this range, the polarizing plate can be applied to an optical display apparatus.

The polarizing plate may have a thickness of about 50 μm to about 300 μm. Within this range, the polarizing plate can be applied to an optical display apparatus.

The polarizing plate may be prepared by any suitable method. For example, the adhesive composition may be coated onto one surface of the protective film, thereby preparing a protective film having an adhesive composition layer. The adhesive composition layer may be dried, if needed. The adhesive composition may be coated by any suitable coating method, for example, die coating, roll coating, gravure coating, or spin coating. The protective film having the adhesive composition layer may be stacked on each of the upper (e.g., first surface) and lower (e.g., second surface) surfaces of the polarizer such that the adhesive composition layer contacts the polarizer. The adhesive composition may then be cured by UV irradiation to form an adhesive layer, thereby preparing a polarizing plate.

The UV irradiation may be performed at a power of about 10 mJ/cm² to about 1,000 mJ/cm², a wavelength of about 200 nm to about 450 nm, and an irradiance of 1 mW/cm² to 500 mW/cm², but the UV irradiation is not limited thereto.

The UV irradiation may be performed using a metal halide lamp, or the like. The UV irradiation may be performed at about 22° C. to about 25° C., and at about 20% RH to about 60% RH.

In accordance with a further aspect of the present invention, a display apparatus may include the polarizing plate described above. For example, the display apparatus may include a liquid crystal display, an OLED display, or the like, but is not limited thereto.

FIG. 2 is a schematic cross-sectional view of a display apparatus according to one embodiment of the present invention. Referring to FIG. 2, the display apparatus may include: a display panel 200; and a polarizing plate 110 on an upper surface (e.g., a first surface) of the display panel 200.

Hereinafter, the present invention will be described with reference to some examples. It should be understood that these examples are provided for illustration only and are not to be construed in any way as limiting the present invention.

List of components used in the Examples and Comparative Examples:
A. Non-(meth)acrylate type epoxy compound
   (A1) Bisphenol A aromatic epoxy (KDS-8128, Kukdo Chemical Co., Ltd.)
   (A2) Hydrogenated epoxy (YX-8000, JER Co., Ltd.)
   (A3) Alicyclic cycloepoxy (SEE-4221, Seechem Co., Ltd.)
B. Non-epoxy type (meth)acrylate compound
   (B1) 2-hydroxyethyl acrylate (100%, SK CYTEC Co., Ltd.)
   (B2) 4-hydroxybutyl acrylate (100%, Osaka Organic Co., Ltd., JAPAN)
   (B3) Phenoxyethyl acrylate (M-140, Miwon Co., Ltd.)
   (B4) 2-hydroxy-3-phenoxypropyl acrylate (M600A, Kyoeisha)
C. (Meth)acrylate group-containing epoxy compound
   (C1) Bisphenol A epoxy diacrylate (PE210, Miwon Co., Ltd.)
   (C2) Bisphenol A epoxy acrylate (EA-1010N, Shin Nakamura Co., Ltd.)
D. Photosensitizer: Thioxanthone (DETX-S, Nippon Kayaku Co., Ltd.)
E. Photocationic polymerization initiator: iodonium salt, hexafluorophosphate (Irgacure-250, BASF Co., Ltd.)

### EXAMPLES 1 TO 12 AND COMPARATIVE EXAMPLES 1 TO 4

Without solvents, a non-(meth)acrylate type epoxy compound, a non-epoxy type (meth)acrylate compound, and a (meth)acrylate group-containing epoxy compound were mixed in the amounts listed in Table 1 (unit: parts by weight), below. In each Example, 1 part by weight of the photosensitizer identified above and 3 parts by weight of the photocationic polymerization initiator identified above were mixed with the mixture, thereby preparing an adhesive composition for polarizing plates.

TABLE 1

| | (A) | | | (B) | | | | (C) | |
|---|---|---|---|---|---|---|---|---|---|
| | (A1) | (A2) | (A3) | (B1) | (B2) | (B3) | (B4) | (C1) | (C2) |
| Example 1 | 50 | — | — | 49 | — | — | — | 1 | — |
| Example 2 | 50 | — | — | 45 | — | — | — | 5 | — |
| Example 3 | 50 | — | — | 40 | — | — | — | 10 | — |
| Example 4 | — | 50 | — | 45 | — | — | — | 5 | — |
| Example 5 | — | — | 50 | 45 | — | — | — | 5 | — |
| Example 6 | — | — | 50 | — | 45 | — | — | 5 | — |
| Example 7 | — | — | 50 | — | 30 | 15 | — | 5 | — |
| Example 8 | — | — | 50 | — | 30 | — | 15 | 5 | — |
| Example 9 | — | — | 50 | — | 30 | 15 | — | — | 5 |
| Example | — | — | 50 | — | 30 | — | 15 | — | 5 |
| 10 | | | | | | | | | |
| Example | — | — | 50 | — | 30 | — | 15 | — | 5 |
| 11 | | | | | | | | | |
| Example | — | — | 50 | — | 30 | — | 15 | — | 5 |
| 12 | | | | | | | | | |
| Compar- | 40 | — | — | 60 | — | — | — | — | — |
| ative | | | | | | | | | |
| Example 1 | | | | | | | | | |
| Compar- | 50 | — | — | 50 | — | — | — | — | — |
| ative | | | | | | | | | |
| Example 2 | | | | | | | | | |
| Compar- | — | — | — | 60 | — | — | — | 40 | — |
| ative | | | | | | | | | |
| Example 3 | | | | | | | | | |
| Compar- | 60 | — | — | — | — | — | — | 40 | — |
| ative | | | | | | | | | |
| Example 4 | | | | | | | | | |

### Preparation of Polarizing Plate

An 80 μm thick polyvinyl alcohol film (degree of saponification: 99.5 mol %, degree of polymerization: 2,000) was dyed in a 0.3% aqueous iodine solution, followed by stretching at a stretching ratio of 5.0. Next, the stretched polyvinyl alcohol film was subjected to color compensation in a 3% boric acid solution and in a 2% aqueous solution of potassium iodide, followed by drying at 50° C. for 4 minutes, thereby preparing a polarizer (thickness: 20 μm).

A triacetyl cellulose film (TAC, thickness: 80 μm) was subjected to corona treatment at 250 mJ/cm² or greater, and a cyclic olefin resin (thickness: 30 μm, collectively referring to resins polymerized using cyclic olefin as a polymerizaton unit (cyclic olefin polymer, COP)) was subjected to corona treatment at 250 mJ/cm² or greater. A poyethylene terephthalate film (PET, thickness: 100 μm) was subjected to corona treatment at 250 mJ/cm² or greater, and an acryl film (thickness: 40 μm) was subjected to corona treatment at 250 mJ/cm² or greater.

The upper and lower protective films were bonded to the polarizer as indicated in Table 2, below. Using each of the adhesive compositions prepared in the Examples and Comparative Examples, the upper protective film, the adhesive, the polarizer, the adhesive and the lower protective film were sequentially laminated at 22° C. to 25° C. and at 20% RH to 60% RH, followed by UV irradiation at 400 mW/cm² and 1000 mJ/cm² using a metal halide lamp, thereby preparing a polarizing plate.

The prepared polarizing plates were evaluated as to (1) adhesion and (2) adhesion after dipping in hot water. (1) Adhesion

To confirm adhesion of each of the polarizing plates, a cutter was inserted between the protective film and the polarizer at one end of the polarizing plate. A polarizing plate which did not as allow insertion of the cutter between the protective film and the polarizer was rate as ⊚, a polarizing plate which allowed slight insertion of the cutter was rated as ◯, a polarizing plate which allowed slight insertion of the cutter and suffered from tearing of the protective film due to a certain strength during insertion of the cutter was rated as Δ, and a polarizing plate which allowed easy insertion of the cutter was rated as ×. The results are shown in Table 2 below.

### (2) Adhesion After Dipping in Hot Water

Each of the prepared polarizing plates was cut to prepare a sample having a size of 5 cm×5 cm (width×length). Next, each of the samples was dipped in constant temperature water (60° C.) for 2 hours. A sample which did not allow insertion of the cutter between the protective film and the polarizer was rated as ⊚, a sample which allowed slight insertion of the cutter was rated as ◯, a sample which allowed slight insertion of the cutter and suffered from tearing of the protective film due to a certain strength during insertion of the cutter was rated as Δ, and a sample which allowed easy insertion of the cutter to cause separation of the protective film was rated as ×. The results are shown in Table 2 below.

TABLE 2

| | | | | | Adhesion after hot | |
|---|---|---|---|---|---|---|
| | Protective film | | Adhesion | | water dipping | |
| | Upper | Lower | Upper | Lower | Upper | Lower |
| Composition | side | side | side | side | side | side |
| Example 1 | TAC | COP | ◯ | ◯ | ◯ | ◯ |
| Example 2 | TAC | COP | ◯ | ◯ | ⊚ | ◯ |
| Example 3 | TAC | COP | ⊚ | ◯ | ⊚ | ◯ |
| Example 4 | TAC | COP | ◯ | ⊚ | ⊚ | ⊚ |
| Example 5 | TAC | COP | ◯ | ⊚ | ⊚ | ⊚ |
| Example 6 | TAC | COP | ◯ | ◯ | ◯ | ⊚ |
| Example 7 | TAC | COP | ◯ | ◯ | ⊚ | ⊚ |
| Example 8 | TAC | COP | ⊚ | ◯ | ⊚ | ⊚ |
| Example 9 | TAC | COP | ⊚ | ◯ | ⊚ | ⊚ |
| Example 10 | TAC | COP | ◯ | ⊚ | ◯ | ⊚ |
| Example 11 | PET | COP | ⊚ | ⊚ | ⊚ | ⊚ |
| Example 12 | Acryl | COP | ◯ | ⊚ | ⊚ | ⊚ |
| Comparative | TAC | COP | X | X | X | X |
| Example 1 | | | | | | |
| Comparative | TAC | COP | Δ | Δ | X | X |
| Example 2 | | | | | | |
| Comparative | TAC | COP | Δ | Δ | Δ | Δ |
| Example 3 | | | | | | |
| Comparative | TAC | COP | Δ | Δ | Δ | Δ |
| Example 4 | | | | | | |

As shown in Table 2, the polarizing plates including adhesive layers formed of the adhesive compositions according to embodiments of the present invention exhibited good adhesion, did not suffer from deteriorations in adhesion even after dipping in hot water, and did not suffer from separation of the protective film.

Therefore, the adhesive compositions for polarizing plates according to embodiments of the present invention can realize an adhesive layer which exhibits reliable moisture resistance and adhesion under severe moisture permeable environments, such as waterlogging environments, high humidity environments, and the like. In addition, the adhesive compositions for polarizing plates according to embodiments of the present invention can realize an adhesive layer which exhibits high cross-linking density and reliability, and good adhesion even under severe moisture permeable environments, such as waterlogging environments, high humidity environments, and the like.

Conversely, it was confirmed that the polarizing plates of Comparative Examples 1 to 2 (which did not include the (meth)acrylate type epoxy compound) suffered from significant deteriorations in adhesion and separation of the protective film after dipping in hot water, and that the polarizing plates of Comparative Examples 1 to 2 suffered from significant deteriorations in adhesion of the adhesive layer under waterlogging or high humidity conditions.

In addition, the polarizing plates of Comparative Examples 3 to 4 (which included the (meth)acrylate type epoxy compound but did not include the non-(meth)acrylate type epoxy compound or the non-epoxy type (meth)acrylate compound) suffered deteriorations in adhesion and durability.

While certain exemplary embodiments of the present invention have been shown and described, it should be understood that various modifications, changes, alterations, and equivalent embodiments can be made by those skilled in the art without departing from the spirit and scope of the present invention, as defined in the following claims.

What is claimed is:

1. An adhesive composition for polarizing plates, comprising:
a non-(meth)acrylate type epoxy compound;
a non-epoxy type (meth)acrylate compound; and
a (meth)acrylate group-containing epoxy compound.

2. The adhesive composition according to claim 1, wherein the (meth)acrylate group-containing epoxy compound comprises an aromatic epoxy group-containing monofunctional or polyfunctional (meth)acrylate.

3. The adhesive composition according to claim 1, wherein the (meth)acrylate group-containing epoxy compound has a hydroxyl group.

4. The adhesive composition according to claim 1, wherein the (meth)acrylate group-containing epoxy compound comprises at least one of bisphenol A epoxy (meth)acrylate, bisphenol A epoxy di(meth)acrylate, bisphenol F epoxy (meth)acrylate, or bisphenol F epoxy di(meth)acrylate.

5. The adhesive composition according to claim 1, wherein the (meth)acrylate group-containing epoxy compound is present in an amount of about 0.5 wt % to about 19 wt % based on a total solids content of the adhesive composition.

6. The adhesive composition according to claim 1, wherein the non-epoxy type (meth)acrylate compound and the (meth)acrylate group-containing epoxy compound are present in the adhesive composition in a total amount of about 60 wt % or less.

7. The adhesive composition according to claim 1, wherein the non-(meth)acrylate type epoxy compound comprises at least one of an alicyclic epoxy compound, an aromatic epoxy compound, an aliphatic epoxy compound, or a hydrogenated epoxy compound.

8. The adhesive composition according to claim 1, wherein the non-epoxy type (meth)acrylate compound comprises a hydroxyl group-containing (meth)acrylate compound or carboxylic acid group-containing (meth)acrylate compound.

9. The adhesive composition according to claim 8, wherein the non-epoxy type (meth)acrylate compound further comprises an aromatic group-containing (meth)acrylate compound.

10. The adhesive composition according to claim 9, wherein the non-epoxy type (meth)acrylate compound has a weight ratio of the hydroxyl group-containing (meth)acrylate compound or carboxylic acid group-containing (meth)acrylate compound to the aromatic group-containing (meth)acrylate compound of about 1:0.5 to about 1:2.

11. The adhesive composition according to claim 9, wherein the aromatic group-containing (meth)acrylate compound is present in the adhesive composition in an amount of about 0.1 wt % to about 15 wt %.

12. The adhesive composition according to claim 1, further comprising:
a photosensitizer; and
a photocationic polymerization initiator.

13. The adhesive composition according to claim 1, wherein:
the non-(meth)acrylate type epoxy compound is present in an amount of about 40 wt % to about 90 wt % based on a total solids content of the adhesive composition;
the non-epoxy type (meth)acrylate compound is present in an amount of about 9 wt % to about 50 wt % based on a total solids content of the adhesive composition; and
the (meth)acrylate group-containing epoxy compound is present in an amount of about 0.5 wt % to about 19 wt % based on a total solids content of the adhesive composition.

14. The adhesive composition according to claim 12, wherein the photosensitizer is present in an amount of about 0.1 parts by weight to about 10 parts by weight based on 100 parts by weight of the non-(meth)acrylate type epoxy compound, the non-epoxy type (meth)acrylate compound, and the (meth)acrylate group-containing epoxy compound combined.

15. The adhesive composition according to claim 12, wherein the photocationic polymerization initiator is present in an amount of about 0.1 parts by weight to about 10 parts by weight based on 100 parts by weight of the non-(meth)acrylate type epoxy compound, the non-epoxy type (meth)acrylate compound, and the (meth)acrylate group-containing epoxy compound combined.

16. The adhesive composition according to claim 12, wherein the photosensitizer comprises thioxanthone.

17. A polarizing plate comprising:
a polarizer;
an adhesive layer on at least one surface of the polarizer, the adhesive layer comprising a cured product of the adhesive composition of claim 1; and
a protective film on the adhesive layer.

18. A display apparatus, comprising the polarizing plate according to claim 17.
